(19) United States
(12) Patent Application Publication
(10) Pub. No.: US 2026/0128985 A1
(43) Pub. Date: May 7, 2026

(54) ROUTE-BASED SERVICE CHAINING OF APPLICATIONS AND NETWORK SERVICES

(71) Applicant: LEVEL 3 COMMUNICATIONS, LLC, Denver, CO (US)

(72) Inventors: Michael Feldpusch, Murrells Inlet, SC (US); Stephen Powell, Brighton, MI (US); Bobby W. Metz, Johnson City, TN (US)

(73) Assignee: LEVEL 3 COMMUNICATIONS, LLC, Denver, CO (US)

(21) Appl. No.: 19/380,576

(22) Filed: Nov. 5, 2025

Related U.S. Application Data
(60) Provisional application No. 63/717,056, filed on Nov. 6, 2024.

(51) Int. Cl. H04L 45/74

(52) U.S. Cl. CPC H04L 45/74

(57) ABSTRACT

Novel tools and techniques are provided for implementing route-based service chaining of applications. In various examples, after receiving a data packet, at least one router may determine a plurality of routes to a destination address associated with the data packet, based on route announcements advertised by a plurality of service applications. The at least one router may select each of the routes based on at least routing policies and local preference values associated with the plurality of routes. The at least one router may send the data packet to each service application in turn over routes among the plurality of routes from highest priority to lowest priority, with the data packet returning to the at least one router after traversing through a service application(s) along each route, until the data packet is sent over the final route to a customer device at the destination address.

### CROSS-REFERENCE TO RELATED APPLICATIONS

This application claims the benefit of U.S. Provisional Application No. 63/717,056 filed Nov. 6, 2024, entitled “Route-Based Service Chaining of Applications and Network Services,” which is incorporated herein by reference in its entirety.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing service chaining, and, more particularly, to methods, systems, and apparatuses for implementing route-based service chaining of applications and network services.

### BACKGROUND

Service chaining of applications may be used to connect network services in a virtual chain to enable the network services to be performed on data or data packets being routed through the virtual chain. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing route-based service chaining of applications, in accordance with various embodiments.

FIGS. 2A and 2B depict various example data flows for implementing route-based service chaining of applications, in accordance with various embodiments.

FIGS. 3A and 3B depict flow diagrams illustrating an example method for implementing route-based service chaining of applications, in accordance with various embodiments.

FIG. 4 depicts a flow diagram illustrating another example method for implementing route-based service chaining of applications, in accordance with various embodiments.

FIG. 5 depicts a block diagram illustrating an exemplary computer or system hardware architecture, in accordance with various embodiments.

### DETAILED DESCRIPTION OF CERTAIN EMBODIMENTS

### Overview

Servicing chaining is a method that stitches multiple network services together in a linear fashion. Conventionally, this is performed using containers and some virtual machines, but does not include appliances or other systems outside the physical system that is hosting the service chain of services. Service chaining uses next-hop routing, where the exit of one service is fed directly into another. This can cause issues if a service within the chain breaks, and the previous service does not have a destination. Also, the order of the chain is defined and cannot be customized on how the services are aligned in the chain.

The present technology is directed to a route-based service chain that utilizes route announcements in conjunction with route-policy and communities to stitch network services together in a service chain of applications or service applications, regardless of the location of the network service that is being stitched in. The network services may be applied to data packets being routed through the service chain in the order of the service applications in the service chain. The order of the chain is adaptable and not static. Rather, the order of the chain is defined by metrics on the route announcement, allowing any priority whether its application defined, or customer defined. As used herein, routing refers to the selection of the best path for a data packet on a system connected to a network. The selection process is based on a defined set of rules called routing protocols. Border gateway protocol (“BGP”) is an example of a routing protocol for communications between large networks or networks that have Internet protocol (“IP”) space and for data that is routed between different service providers or between virtual networks within any type of IP network. Each large network is identified by an Autonomous Serial Number (“ASN”) and is unique to that network. BGP also serves as a standardized gateway protocol for exchanging routing and reachability information among autonomous systems (“ASs”) on the Internet (in which case, exterior BGP or eBGP is used) or among peers in the same AS (in which case, interior BGP or iBGP is used). As used herein, communities or BGP communities refer to essentially private or isolated BGP routing instances where routes may be exchanged between networks, but do not need an associated unique ASN for exchanging routes. In some cases, BGP communities may be denoted by values that are used to mark IP routes in order to identify how and when to selectively process the IP routes (e.g., when including such IP prefixes within a specific IP network, or the like). For example, within an entity's ASN, there may be several communities that are part of the ASN but are private on what traffic are permitted to traverse over those communities. In an example, a distributed denial of service (“DDoS”) cleaned traffic return network may be community XXX. A customer needs to peer with that community in order for traffic destined for that customer's network, to know how to route there if the traffic is on that DDoS private network.

In various examples, after receiving a data packet and determining a customer IP prefix associated with a destination address of the data packet, a router may determine a plurality of routes to the destination address, based on route announcements advertised by a plurality of service applications. The router may select each of the routes based on at least routing policies and local preference values associated with the plurality of routes, and may send the data packet to a first service application based on the highest priority advertised route. In some examples, while the source address does not generally influence the selection of the first service application based on the highest priority of advertised routes, the source address can be used to override the typical order of the service chain at one or more points along the chain. After receiving the data packet back from the first service application, the router may send the data packet to the next service application over the next highest priority route, and so on, in a route-based service chain of service applications. In some examples, the data packet returns to the router after traversing through each service application before traversing to the next service application in the next highest priority route, until the data packet is sent over the final route to a customer device at the destination address. In other examples, the traffic (or data packet(s)) may not return to the originating router which passed the packet to the current service application, but instead to a different router that can connect the current service application to the next service application. Also, while the ordering of a service chain is typically fixed, that does not restrict each link in the chain from connecting to two or more other service applications, thus allowing for the flexible chaining of services for different needs per destination IP prefixes. In this manner, the order and construction of the service chain can be accomplished through routing policies rather than by statically generating a container of chained service applications. This permits greater flexibility in the construction, priority, and adaptability of service chains in case of, for example, a failure of an instance of a service application in the chain, a change in preferred service chain order, or otherwise.

These and other aspects of the route-based service chaining of applications are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values, etc.).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Aspects of the present invention, for example, are described below with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

In an aspect, the technology relates to a method, including receiving, by at least one router, a routing policy; and receiving, by the at least one router, route announcements, including route announcements that are advertised by a plurality of service applications. The method may further include receiving, by the at least one router, a data packet; and determining, by the at least one router, a customer IP prefix associated with a destination address of the data packet, the customer IP prefix corresponding to a customer device. The method may also include determining, by the at least one router and based on the route announcements, a plurality of routes to the destination address, including a first route through a first service application of the plurality of service applications, a second route through a second service application of the plurality of service applications, and a third route not associated with the plurality of service applications. The method may further include selecting, by the at least one router and based on at least the routing policy and local preference values associated with the plurality of routes, the first route to route the data packet; sending, by a first router among the at least one router, the data packet to the first service application via the first route; and receiving, by one of the first router or a second router among the at least one router, the data packet from the first service application. The method may also include selecting, by the at least one router and based on at least the routing policy and local preference values associated with the plurality of routes, the second route to route the data packet; sending, by the one of the first router or the second router, the data packet to the second service application via the second route; receiving, by one of the first router, the second router, or a third router among the at least one router, the data packet from the second service application. The method may further include selecting, by the at least one router and based on at least the routing policy and local preference values associated with the plurality of routes, the third route to route the data packet; and sending, by the one of the first router, the second router, or the third router, the data packet to the customer device via the third route.

In another aspect, the technology relates to a router, including a processing system and a memory coupled to the processing system. The memory includes computer executable instructions that, when executed by the processing system, causes the router to perform operations including receiving route announcements, including route announcements that are advertised by a plurality of service applications; receiving a data packet; determining a customer IP prefix associated with a destination address of the data packet, the customer IP prefix corresponding to a customer device; determining, based on the route announcements, a plurality of routes to the destination address, including a first route through a first service application of the plurality of service applications, a second route through a second service application of the plurality of service applications, and a third route not associated with the plurality of service applications; selecting, based on at least the routing policy and local preference values associated with the plurality of routes, the first route to route the data packet; sending the data packet to the first service application via the first route; receiving the data packet from the first service application; selecting, based on at least the routing policy and local preference values associated with the plurality of routes, the second route to route the data packet; sending the data packet to the second service application via the second route; receiving the data packet from the second service application; selecting, based on at least the routing policy and local preference values associated with the plurality of routes, the third route to route the data packet; and sending the data packet to the customer device via the third route.

In yet another aspect, the technology relates to a system, including at least one of network device hosting a plurality of service applications and one or more routers. Each router may be configured to: receive a routing policy; receive route announcements, including route announcements that are advertised by the plurality of service applications; receive a data packet; determine a customer IP prefix associated with a destination address of the data packet, the customer IP prefix corresponding to a customer device; determine, based on the route announcements, a plurality of routes to the destination address, including a first route through a first service application of the plurality of service applications, a second route through a second service application of the plurality of service applications, and a third route not associated with the plurality of service applications; select, based on at least the routing policy and local preference values associated with the plurality of routes, the first route to route the data packet; send the data packet to the first service application via the first route; receive the data packet from the first service application; select, based on at least the routing policy and local preference values associated with the plurality of routes, the first route to route the data packet; send the data packet to the second service application via the second route; receive the data packet from the second service application; select, based on at least the routing policy and local preference values associated with the plurality of routes, the third route to route the data packet; and send the data packet to the customer device via the third route. Each of the first service application and the second service application may be further configured to: receive a service chaining request from a customer associated with the customer device, the service chaining request including a request for the first and second service applications to perform network services on data packets that are addressed to the customer IP prefix; advertise its route announcements to the one or more routers, its route announcements indicating to route data packets to the customer IP prefix through the service application, wherein its route announcements include its local preference value; receive the data packet from the router; perform at least one network service on data packet; and send the data packet back to the router.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

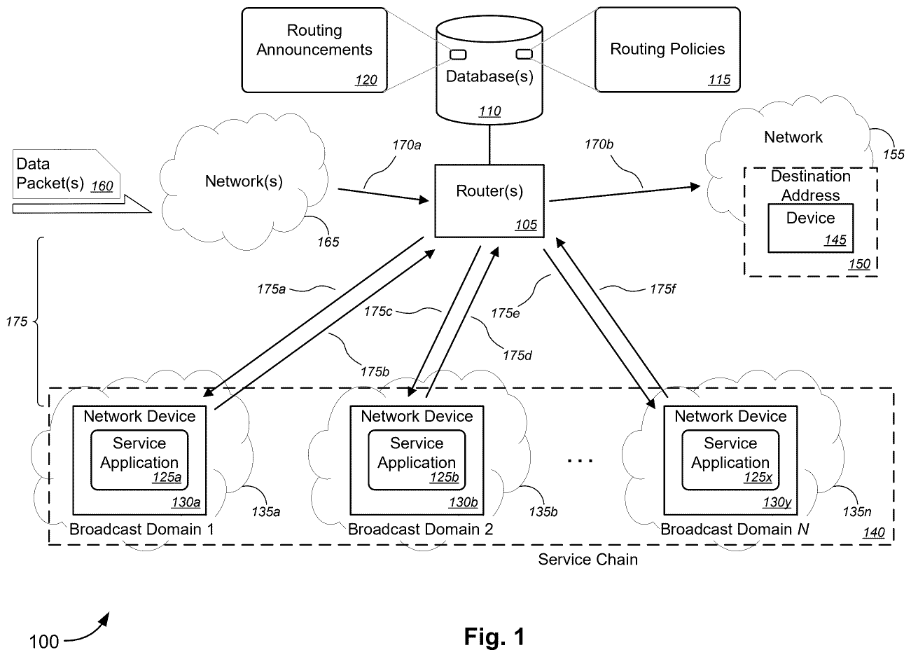

Turning to the embodiments as illustrated by the drawings, FIGS. 1-5 illustrate some of the features of methods, systems, and apparatuses for implementing service chaining, and, more particularly, to methods, systems, and apparatuses for implementing route-based service chaining of applications, as referred to above. The methods, systems, and apparatuses illustrated by FIGS. 1-5 refer to examples of different embodiments that include various components and steps, which can be considered alternatives or which can be used in conjunction with one another in the various embodiments. The description of the illustrated methods, systems, and apparatuses shown in FIGS. 1-5 is provided for purposes of illustration and should not be considered to limit the scope of the different embodiments.

With reference to the figures, FIG. 1 depicts an example system 100 for implementing route-based service chaining of applications, in accordance with various embodiments. As shown in FIG. 1, system 100 may include one or more routers 105 and corresponding database(s) 110. On the database(s) 110 may be stored one or more routing policies 115 and one or more routing announcements 120. The system 100 may further include a plurality of service applications 125a-125x (collectively, “service applications 125” or the like) that are hosted on one or more network devices 130a-130y (collectively, “network devices 130” or the like). In examples, the plurality of service applications 125 provides a corresponding plurality of network services including at least one of firewall services, DDoS mitigation services, network analytics services, content cache services, or encryption services. In some examples, the one or more network devices 130 may include routers, servers, or other network equipment that is suitable to host service applications 125 and to relay data (e.g., data packets, or the like). In some embodiments, the network devices 130 may be located in one or more broadcast domains 135a-135n. Herein, n, x, and y are non-negative integer numbers that may be either all the same as each other, all different from each other, or some combination of same and different (e.g., one set of two or more having the same values with the others having different values, a plurality of sets of two or more having the same value with the others having different values, etc.). In some examples, the plurality of service applications 125a-125x may form a service chain 140 to perform, by the service applications 125a-125x, a corresponding plurality of network operations on incoming data packets (e.g., data packet(s) 160 received by router(s) 105 via network(s) 165, or the like) in a particular sequence or order of the service chain 140, prior to the data packets being sent, by router(s) 105, to device 145 at destination address 150 in network 155.

According to some embodiments, routing by the router(s) 105 is performed using BGP. In examples, the one or more routing policies 115 may serve as a basis by which the one or more routers 105 route data within the network(s) (e.g., networks 165, 155, and 135a-135n, and/or the like). In some embodiments, the one or more routing policies 115 are provided by a service provider that provisions, offers, or provides the service chaining functionalities to customers, to the one or more routers 105 as well as to other routers tasked with providing service chaining functionalities. In examples, the one or more routing policies 115 may include a policy to route data packets to the highest priority local preference values. The one or more routing policies 115 may further include, for each service chain 140, a policy to prevent packet loop back by either changing a local preference value of, or ignoring, a route from which the router receives data packets. In another example, the one or more routing policies 115 may (further) include, for each service chain, a policy to route data packets via a route with the next highest priority local preference value when a service application corresponding to a route with the highest priority local preference stops advertising its route announcements. In some examples, while the source address does not generally influence the selection of the first service application based on the highest priority of advertised routes, the source address can be used to override the typical order of the service chain at one or more points along the chain. These are merely examples of potential routing policies that may be used when implementing route-based service chaining of applications, the various embodiments are not limited to these particular routing policies, and any suitable routing policies may be used and/or implemented.

In some embodiments, for coordinating between routers and local announcements for service applications that are in different locations, the system may use routing traffic preferences that are defined by IP architecture and that are configured on the router by automation. For example, if the router knows that “this route is being announced from DDoS,” the router knows that the predefined metric associated with that service, and knows that other applications in the service chain will have predefined set metrics since the local preference is attached and announced from the router, rather than the application announcing the specific route. In the case of both a local and a remote service application, the definition of the routing priorities would be coupled with local policy on each router, thus providing every router with a clear choice of when to prefer local over remote, or vice versa. In examples, the router would potentially make different choices in certain cases when coupled with additional controls that can selectively override the highest priority next hop based on the plurality of routes.

According to some embodiments, networks 135a-135n, 155, and/or 165 may each include, without limitation, one of a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the networks 135a-135n, 155, and/or 165 may include an access network of the service provider (e.g., an Internet service provider (“ISP”)). In another embodiment, the networks 135a-135n, 155, and/or 165 may include a core network of the service provider and/or the Internet.

In some instances, the device 145 may include, but is not limited to, one of a desktop computer, a laptop computer, a tablet computer, a smart phone, a mobile phone, a server, a router, a switch, or other suitable equipment. In some cases, a customer or user associated with the device 145 may include, without limitation, one of an individual, a group of individuals, a private company, a group of private companies, a public company, a group of public companies, an institution, a group of institutions, an association, a group of associations, a governmental agency, a group of governmental agencies, or any suitable entity or their agent(s), representative(s), owner(s), and/or stakeholder(s), or the like.

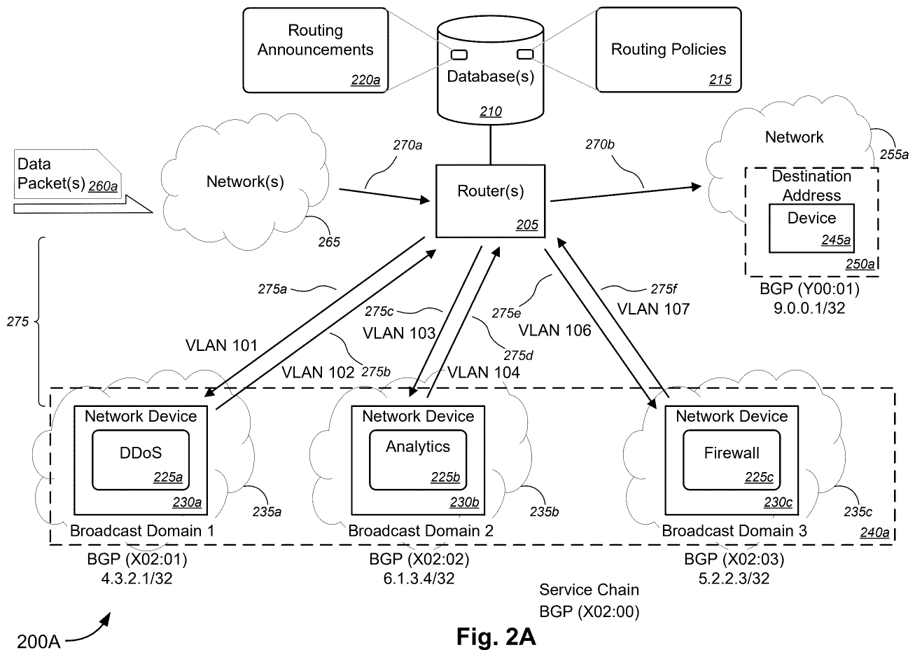

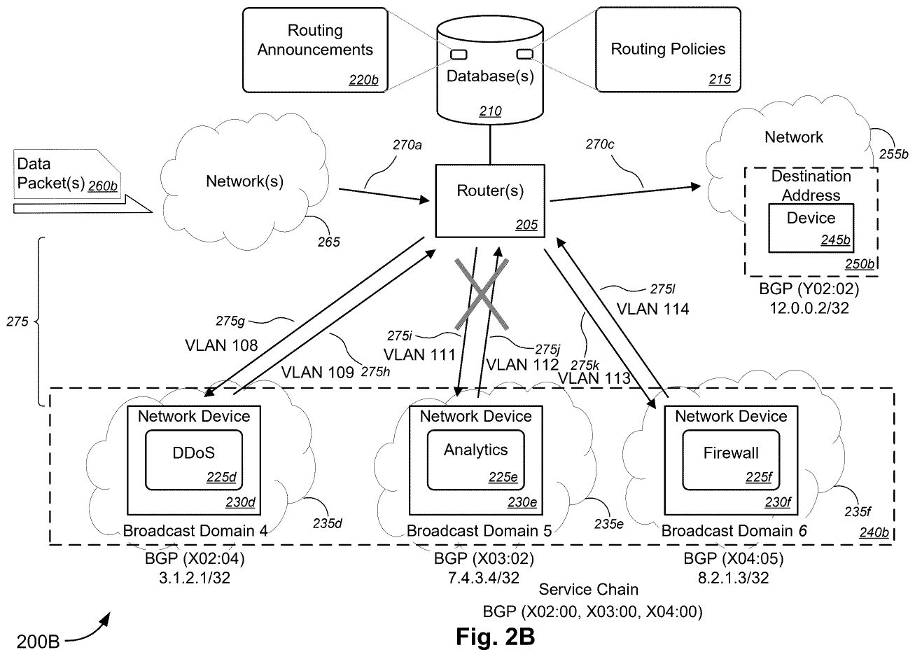

In operation, router(s) 105, service applications 125a-125x, and/or network device(s) 130a-130y (collectively, “computing system”) may perform methods for implementing route-based service chaining of applications, as described in detail with respect to FIGS. 2-4. For example, in response to receiving data packet(s) 160 via network(s) 165 and route 170a, router(s) 105 may determine a customer Internet protocol (“IP”) prefix associated with destination address 150 of the data packet(s) 160, the customer IP prefix corresponding to device 145. As used herein, an IP prefix may refer to an aggregation of continuous IP addresses into blocks delineated by the subnet mask. The subnet mask may be depicted in classless inter-domain routing (“CIDR”) notation, which is determined by the number of ‘high’ bits in the mask. Unique prefixes may be announced from unique networks (or ASNs) via the BGP routing protocol. Based on the routing announcements, which includes the routing announcements 120 advertised by service applications 125a-125x related to service chain 140 of applications ordered by a customer associated with device 145 and/or destination address 150, router(s) 105 may determine a plurality of routes 175. The plurality of routes 175 include a first route 175a to service application 125a, a second route 175c to service application 125b, through an X^{th} route 175e to service application 125x, and a final route 170b to device 145. Based on at least the routing policies 115 and local preference values associated with the plurality of routes 175, the router(s) 105 may select the first route 175a to route the data packet(s) 160, and may send the data packet(s) 160 to the service application 125a. When router(s) 105 receives the data packet(s) 160 from service application 125a and from broadcast domain 135a over route 175b, router(s) 105 may change the local preference value of the first route 175a to prevent packet loop back. Router(s) 105 repeats the selection, sending, and local preference change for each of the subsequent routes (e.g., second route 175c through X^{th} route 175e) and corresponding service applications (e.g., service applications 125b through 125x). Here, the first route 175a originally has the highest priority based on its local preference value (e.g., a preference value of 100, or the like), while the last route 170b has the lowest priority based on its local preference value (e.g., a preference value of 1000, or the like), with the intermediate routes 175c through 175e having monotonically decreasing priorities based on their local preference values (e.g., each with a preference value of between 100 and 1000, or the like). If any of the service applications 125a-125x stops advertising routing announcements, the router(s) 105 may skip routes 175 associated with such service applications 125, and instead route to the next highest priority based on local preference values, until the data packet(s) is sent to the device 145 over route 170b. Other methods of avoiding loop back to an application that has already processed a packet are possible and contemplated.

Because the route-based service chain utilizes route announcements and the order of the service chain is defined by metrics on the route announcement and routing policies, priority of the service applications in the service chain may be defined or redefined, whether by the system and/or by the customer. In examples, however, the service provider may limit the amount of redefinition performed by the customer to avoid issues that may arise with changing of routing priorities during runtime when implementing routing of data in the network.

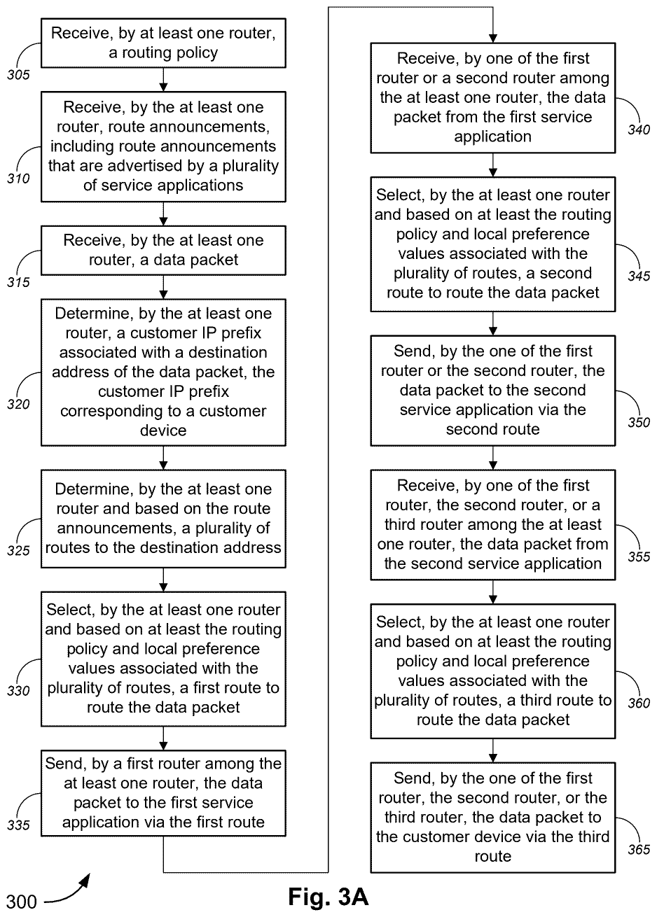

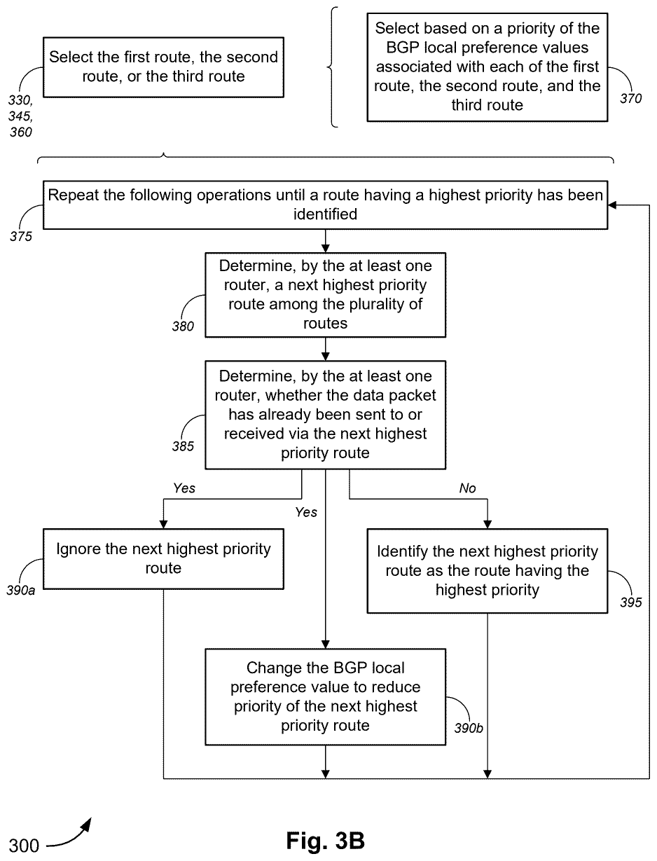

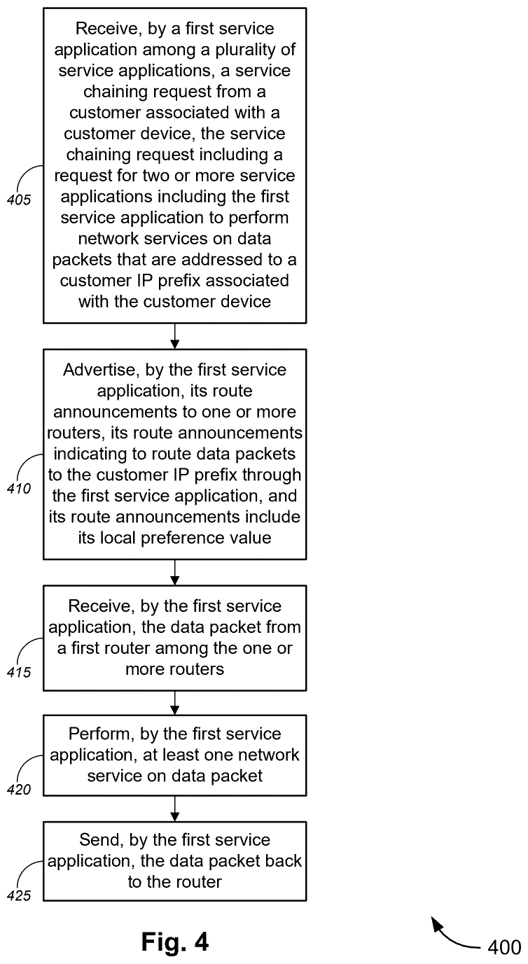

In examples, data flows 200A and 200B as described below with respect to FIGS. 2A and 2B, and methods 300 and 400 as described below with respect to FIGS. 3A-3B and 4 may be applied with respect to the operations of system 100 of FIG. 1.

FIGS. 2A and 2B (collectively, “FIG. 2”) depict various example data flows 200A and 200B for implementing route-based service chaining of applications, in accordance with various embodiments. In some embodiments, router(s) 205, database(s) 210, routing policies 215, routing announcements 220a and 220b, service applications 225a-225f, network devices 230a-230f, broadcast domains 235a-235f, service chains 240a and 240b, devices 245a and 245b, destination addresses 250a and 250b, network 255b, data packet(s) 260a and 260b, network(s) 265, and routes 270a-270c, 275, and 275a-275l of FIG. 2 may be similar, if not identical, to the router(s) 105, database(s) 110, routing policies 115, routing announcements 120, service applications 125a-125x, network devices 130a-130y, broadcast domains 135a-135n, service chain 140, device 145, destination address 150, network 155, data packet(s) 160, network(s) 165, and routes 170a, 170b, 175, and 175a-175f, respectively, of system 100 of FIG. 1, and the description of these components of system 100 of FIG. 1 are similarly applicable to the corresponding components of FIG. 2.

With reference to FIG. 2A, a customer associated with device 245a and/or with destination address 250a may select to have traffic addressed to a particular IP address space of the customer processed through a service chain of applications 240a that includes a DDoS mitigation service application 225a, a domain name system (“DNS”) service application 225b, and a firewall service application 225c. Each of DDoS mitigation service application 225a, DNS service application 225b, and firewall service application 225c may advertise its route or routing announcements for the customer's address space to router(s) 205 as well as to other service applications. The router(s) 205 may receive the routing announcements for the customer's address space from service applications 225a-225c as well as from other service applications, and may store them in database(s) 210 as routing announcements 220a for that address space.

In response to receiving data packet(s) 260a via network(s) 265 and route 270a, router(s) 205 may determine a customer IP prefix associated with destination address 250a of the data packet(s) 260a, the customer IP prefix corresponding to device 245a (in this case, “Y00”). Based on the routing announcements, which includes the routing announcements 220a advertised by service applications 225a-225c related to service chain 240a of applications selected by the customer, router(s) 205 may determine a plurality of routes 275. The plurality of routes 275 include a first route 275a over virtual local area network (“VLAN”) 101 to DDoS mitigation service application 225a (in this case, with IP prefix and domain X02:01, at network address 4.3.2.1/32), a second route 275c over VLAN 103 to DNS service application 225b (in this case, with IP prefix and domain X02:02, at network address 6.1.3.4/32), a third route 275e over VLAN 106 to firewall service application 225c (in this case, with IP prefix and domain X02:03, at network address 5.2.2.3/32), and a final route 270b to device 245a (in this case, with IP prefix and domain Y00:01, at network address 9.0.0.1/32). In this case, the first route 275a has the highest priority, the second route 275c has the next highest priority, the third route 275e has a lower priority, and the final route 270b to device 245a has the lowest priority, based on local preference values associated with these routes. As used herein, preference refers to a weight metric associated with a route announcement. That is, if the same/32 route is being announced from two different sources or applications, and there is a metric or weight associated with each source (which is defined globally on the network routers), then the routers would steer traffic to the application with the higher weight (or higher preference value). For instance, if application 1 has a preference value of 100 and application 2 has a local preference of 200, then, the routers (or the network) would steer the traffic to application 2, because it has the higher weight or priority over application 1. Although both applications are announcing the same route, the traffic priority is toward application 2, in this case. With reference to FIG. 2A, a preference value of 400 for the first route 275a, a preference value of 300 for the second route 275c, a preference value of 200 for the third route 275e, and a preference value of 100 for the final route 270b, or the like, would result in the router(s) 205 routing traffic first over the first route 275a to application 225a, then back to router(s) 205 (or another router(s)) over route 275b, before routing next over the second route 275c to application 225b, then back to router(s) 205 (or another router(s)) over route 275d, before routing next over the third route 275e to application 225c, then back to router(s) 205 (or another router(s)) over route 275f, then finally routing over the final route 270b to device 245a. In some examples, the traffic (e.g., data packet(s)) returns to the router that passed the traffic to the current service application (in this case, router(s) 205) after traversing through the current server application before traversing to the next service application in the next highest priority route. In other examples, the traffic (or data packet(s)) may not return to the originating router which passed the packet to the current service application, but instead to a different router that can connect the current service application to the next service application. Also, while the ordering of a service chain is typically fixed, that does not restrict each link in the chain from connecting to two or more other service applications, thus allowing for the flexible chaining of services for different needs per destination IP prefixes.

Based on at least the routing policies 215 and the local preference values associated with the plurality of routes 275, the router(s) 205 may select the first route 275a to route the data packet(s) 260a, and may send the data packet(s) 260a to the DDoS mitigation service application 225a over the first route 275a (over VLAN 101). When router(s) 205 receives the data packet(s) 260a from DDoS mitigation service application 225a and from broadcast domain 235a over route 275b (over VLAN 102), router(s) 205 may change the local preference value of the first route 275a to prevent packet loop back. In other examples, the router 205 may prevent loop back by never sending a packet on a lower VLAN than the VLAN on which it was received. After receiving the data packet(s) 260a, from the DDoS mitigation service application 225a, the router(s) 205 may select, based on at least the routing policies 215 and the local preference values associated with the plurality of routes 275, the second route 275c to route the data packet(s) 260a, and may send the data packet(s) 260a to the DNS service application 225b over the second route 275c (over VLAN 103). When router(s) 205 receives the data packet(s) 260a from DNS service application 225b and from broadcast domain 235b over route 275d (over VLAN 104), router(s) 205 may change the local preference value of the second route 275c to prevent packet loop back. After receiving the data packet(s) 260a, from the DNS service application 225b, the router(s) 205 may select, based on at least the routing policies 215 and the local preference values associated with the plurality of routes 275, the third route 275e to route the data packet(s) 260a, and may send the data packet(s) 260a to the firewall service application 225c over the third route 275e (over VLAN 106). When router(s) 205 receives the data packet(s) 260a from firewall service application 225c and from broadcast domain 235c over route 275f (over VLAN 107), router(s) 205 may change the local preference value of the third route 275e to prevent packet loop back. After receiving the data packet(s) 260a, from firewall service application 225c, the router(s) 205 may select, based on at least the routing policies 215 and the local preference values associated with the plurality of routes 275, the final route 270b to route the data packet(s) 260a, and may send the data packet(s) 260a to the device 245a over the final route 270b.

Referring to FIG. 2B, a customer associated with device 245b and/or with destination address 250b may order a service chain of applications 240b that includes a DDoS mitigation service application 225d, an Analytics service application 225e, and a firewall service application 225f. Each of DDoS mitigation service application 225d, Analytics service application 225e, and firewall service application 225f may advertise its route or routing announcements to router(s) 205 as well as to other service applications. The router(s) 205 may receive the routing announcements from service applications 225d-225f as well as from other service applications, and may store them in database(s) 210 as routing announcements 220b.

In response to receiving data packet(s) 260b via network(s) 265 and route 270a, router(s) 205 may determine a customer IP prefix associated with destination address 250b of the data packet(s) 260b, the customer IP prefix corresponding to device 245b (in this case, “Y02”). Based on the routing announcements, which includes the routing announcements 220b advertised by service applications 225d-225f related to service chain 240b of applications ordered by the customer, router(s) 205 may determine a plurality of routes 275. The plurality of routes 275 include a first route 275g over VLAN 108 to DDoS mitigation service application 225d (in this case, hosted on network device 230d, with IP prefix and domain X02:04, at network address 3.1.2.1/32), a second route 275i over VLAN 111 to Analytics service application 225e (in this case, with IP prefix and domain X03:02, at network address 7.4.3.4/32), a third route 275k over VLAN 113 to firewall service application 225f (in this case, with IP prefix and domain X04:05, at network address 8.2.1.3/32), and a final route 270c to device 245b (in this case, with IP prefix and domain Y02:01, at network address 12.0.0.2/32). In this case, the first route 275g has the highest priority, the second route 275i has the next highest priority, the third route 275k has a lower priority, and the final route 270c to device 245b has the lowest priority, based on local preference values associated with these routes (e.g., a preference value of 100 for the first route 275g, a preference value of 200 for the second route 275i, a preference value of 300 for the third route 275k, and a preference value of 400 for the final route 270c, or the like).

Based on at least the routing policies 215 and the local preference values associated with the plurality of routes 275, the router(s) 205 may select the first route 275g to route the data packet(s) 260b, and may send the data packet(s) 260b to the DDoS mitigation service application 225d over the first route 275g (over VLAN 108). When router(s) 205 receives the data packet(s) 260b from DDoS service application 225d and from broadcast domain 235d over route 275h (over VLAN 109), router(s) 205 may change the local preference value of the first route 275g to prevent packet loop back. After receiving the data packet(s) 260b, from the DDoS mitigation service application 225d, the router(s) 205 may select, based on at least the routing policies 215 and the local preference values associated with the plurality of routes 275, the second route 275i to route the data packet(s) 260b. However, if Analytics service application 225e stops advertising its routing announcements 220b, the router(s) 205 may skip or ignore the second route 275i, and in some cases may change the local preference value of the second route 275i to change the local preference value of the second route 275i to prevent routing over the second route 275i until the Analytics service application 225e (or another service application from broadcast domain 235e) begins advertising its routing announcements again. Instead of routing to Analytics service application 225e over VLAN 111, router(s) 205 may select, based on at least the routing policies 215 and the local preference values associated with the plurality of routes 275, the third route 275k to route the data packet(s) 260b, and may send the data packet(s) 260b to the firewall service application 225f over the third route 275k (over VLAN 113). When router(s) 205 receives the data packet(s) 260b from firewall service application 225f and from broadcast domain 235f over route 275l (over VLAN 114), router(s) 205 may change the local preference value of the third route 275k to prevent packet loop back. After receiving the data packet(s) 260b, from firewall service application 225f, the router(s) 205 may select, based on at least the routing policies 215 and the local preference values associated with the plurality of routes 275, the final route 270c to route the data packet(s) 260b, and may send the data packet(s) 260b to the device 245b over the final route 270c.

In some aspects, the local preference values on each community (e.g., shown in FIGS. 2A and 2B as broadcast domains 235a-235f) may be used to determine a service chain path. If a service application in the service chain is no longer available or becomes non-operational, data traffic is not affected, only the services being provided by the service applications are affected. In some examples, the last resort exit for all data traffic may be set to the customer destination (e.g., device 245a at destination address 250a or device 245b at destination address 250b). In examples, service insertion may be based on BGP announcements from each service application. Data packets traverse up to the router between service applications. In some examples, service applications may exist on multiple systems within the same facility. In examples, service applications may be hosted on virtual machines, bare metal, or other appliances.

FIGS. 3A and 3B (collectively, “FIG. 3”) depict flow diagrams illustrating an example method 300 for implementing route-based service chaining of applications, in accordance with various embodiments. FIG. 3 is directed to implementing route-based service chaining from the perspective of at least one router.

With reference to FIG. 3A, method 300, at operation 305, may include receiving, by at least one router (e.g., routers 105 and 205 of FIGS. 1 and 2, and/or the like), a routing policy (e.g., routing policies 115 and 215 of FIGS. 1 and 2, and/or the like). At operation 310, the at least one router may receive route announcements (e.g., routing announcements 120, 220a, and 220b of FIGS. 1 and 2, and/or the like), including route announcements that are advertised by a plurality of service applications (e.g., service applications 125a-125x and 225a-225f of FIGS. 1 and 2, and/or the like). In some examples, a service provider that is provisioning the service chaining functionalities to a customer provides the routing policy to a router as well as other routers tasked with providing service chaining functionalities. The routing policy provides the at least one routers with guidelines regarding how to route data within the network(s). In examples, the routing policy may include a policy to route data packets to the highest priority local preference values. The routing policy may further include, for each service chain (e.g., service chains 140, 240a, and 240b of FIGS. 1 and 2, and/or the like), a policy to prevent packet loop back by either changing a local preference value of, or ignoring, a route from which a router receives data packets. In an example, the routing policy may (further) include, for each service chain, a policy to route data packets via a route with the next highest priority local preference value when a service application corresponding to a route with the highest priority local preference stops advertising its route announcements. These are merely examples of potential routing policies that may be used when implementing route-based service chaining of applications, the various embodiments are not limited to these particular routing policies, and any suitable routing policies may be used and/or implemented. In examples, the plurality of service applications provides a corresponding plurality of network services including at least one of firewall services, DDoS mitigation services, network analytics services, content cache services, or encryption services.

Method 300 may further include receiving, by the at least one router, a data packet (at operation 315). Method 300 may further include, at operation 320, determining, by the at least one router, a customer IP prefix associated with a destination address (e.g., destination addresses 150, 250a, and 250b of FIGS. 1 and 2, and/or the like) of the data packet, the customer IP prefix corresponding to a customer device (e.g., devices 145, 245a, and 245b of FIGS. 1 and 2, and/or the like). At operation 325, the at least one router may determine, based on the route announcements, a plurality of routes to the destination address, including a first route through a first service application of the plurality of service applications, a second route through a second service application of the plurality of service applications, and a third route not associated with the plurality of service applications.

At operation 330, the at least one router may select, based on at least the routing policy and local preference values associated with the plurality of routes, the first route to route the data packet. In examples, the local preference values are determined based on one or more of the routing policy or the route announcements. A first router among the at least one router may send the data packet to the first service application via the first route (at operation 335). One of the first router or a second router among the at least one router may receive the data packet from the first service application (at operation 340). At operation 345, the at least one router may select, based on at least the routing policy and local preference values associated with the plurality of routes, the second route to route the data packet. The one of the first router or the second router may send the data packet to the second service application via the second route (at operation 350). One of the first router, the second router, or a third router among the at least one router may receive the data packet from the second service application (at operation 355). At operation 360, the at least one router may select, based on at least the routing policy and local preference values associated with the plurality of routes, the third route to route the data packet. The one of the first router, the second router, or the third router may send the data packet to the customer device via the third route (at operation 365).

In some examples, sending the data packet to the first service application via the first route, to the second service application via the second route, and to the customer device via the third route is based on routing using BGP, wherein the local preference values include BGP local preference values associated with the plurality of network devices. In some cases, the third route mb set to have the lowest priority. In examples, after receiving the data packet from the first service application, the route may ignore, based on the routing policy, the first route to prevent resending the data packet to the first service application. Similarly, after receiving the data packet from the second service application, the route may ignore, based on the routing policy, the second route to prevent resending the data packet to the second service application. This may apply to any of the plurality of service applications from which a router receives data packets. In some examples, two or more of the plurality of service applications (including the first and the second service applications) may each include a broadcast domain (e.g., broadcast domains 135a-135n and 235a-235f of FIGS. 1 and 2, and/or the like) that is separate from the broadcast domain of others of the plurality of service applications. In the example of FIG. 3, the first service application and the second service application form a first service chain that is associated with the customer device. In other examples, a second service chain that is associated with another customer device may be different from the first service chain in terms of at least one of service applications among the plurality of service applications or an order of service applications in each service chain, as shown and described above with respect to the examples of FIGS. 2A and 2B.

Referring to FIG. 3B, selecting each of the first route, the second route, and the third route (at operations 330, 345, and 360, as shown in FIG. 3A) includes selecting these routes based on a priority of the BGP local preference values associated with each of the first route, the second route, and the third route (at operation 370). Alternatively or additionally, selecting each of the first route, the second route, or the third route (at operations 330, 345, and 360, as shown in FIG. 3A) includes repeating the following operations until a route having a highest priority has been identified (at operation 375). At operation 380, the at least one router may determine a next highest priority route among the plurality of routes, and may determine whether the data packet has already been sent to or received via the next highest priority route (at operation 385). Based on a determination that the data packet has already been sent to and/or received from the next highest priority route, the at least one router may either ignore the next highest priority route (at operation 390a) or may change the BGP local preference value to reduce priority of the next highest priority route (at operation 390b). Based on a determination that the data packet has not already been sent to and/or received from the next highest priority route, however, the at least one router may identify the next highest priority route as the route having the highest priority (at operation 395).

FIG. 4 depicts a flow diagram illustrating another example method 400 for implementing route-based service chaining of applications, in accordance with various embodiments. FIG. 4 is directed to implementing route-based service chaining from the perspective of one of the service applications. Method 400 is otherwise similar to method 300 of FIGS. 3A and 3B at least in terms of route-based service chaining of applications.

With reference to FIG. 4, method 400, at operation 405, may include receiving, by a first service application among a plurality of service applications (e.g., service applications 125a-125x and 225a-225f of FIGS. 1 and 2, and/or the like), a service chaining request from a customer associated with a customer device (e.g., devices 145, 245a, and 245b of FIGS. 1 and 2, and/or the like), the service chaining request including a request for two or more service applications among the plurality of service applications (including the first service application) to perform network services on data packets that are addressed to the customer IP prefix. At operation 410, the first service application may advertise its route announcements (e.g., routing announcements 120, 220a, and 220b of FIGS. 1 and 2, and/or the like) to one or more routers in the network(s), its route announcements indicating to route data packets (e.g., data packets 160, 260a, and 260b of FIGS. 1 and 2, and/or the like) to the customer IP prefix through the service application. In some cases, its route announcements may include its local preference value. Method 400 may further include, at operation 415, receiving, by the first service application, the data packet from a first router among the one or more routers (e.g., routers 105 and 205 of FIGS. 1 and 2, and/or the like). Method 400 may further include perform, by the first service application, at least one network service on data packet (at operation 420); and sending, by the first service application, the data packet back to the router (at operation 425).

While the techniques and procedures in methods 300, 400 are depicted and/or described in a certain order for purposes of illustration, it should be appreciated that certain procedures may be reordered and/or omitted within the scope of various embodiments. Moreover, while the methods 300, 400 may be implemented by or with (and, in some cases, are described below with respect to) the systems, examples, or embodiments 100, 200A, and 200B of FIGS. 1, 2A, and 2B, respectively (or components thereof), such methods may also be implemented using any suitable hardware (or software) implementation. Similarly, while each of the systems, examples, or embodiments 100, 200A, and 200B of FIGS. 1, 2A, and 2B, respectively (or components thereof), can operate according to the methods 300, 400 (e.g., by executing instructions embodied on a computer readable medium), the systems, examples, or embodiments 100, 200A, and 200B of FIGS. 1, 2A, and 2B can each also operate according to other modes of operation and/or perform other suitable procedures.

### Exemplary System and Hardware Implementation

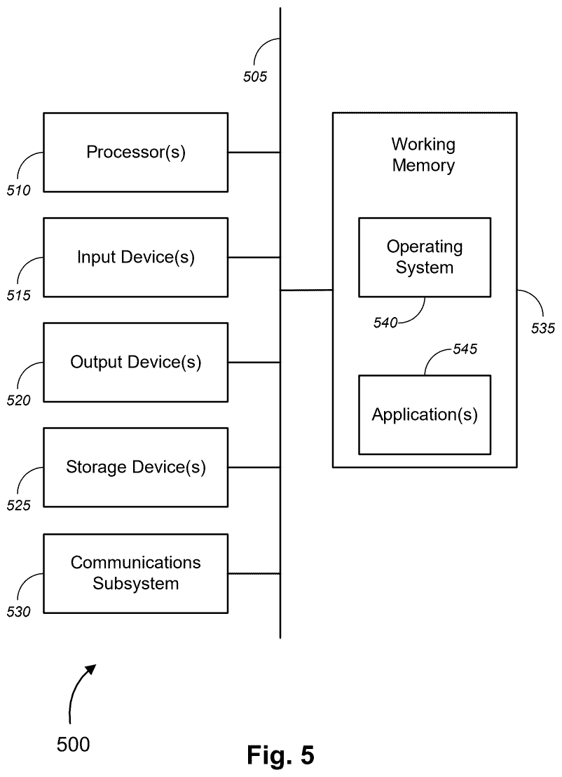

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., routers 105 and 205, service applications 125a-125x and 225a-225f, and/or network devices 130a-130y and 230a-230f, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., routers 105 and 205, service applications 125a-125x and 225a-225f, and/or network devices 130a-130y and 230a-230f, etc.), described above with respect to FIGS. 1-4—is shown including hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can include, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a Wi-Fi device, a WiMAX device, a wireless wide area network (“WWAN”) device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further include a working memory 535, which can include a RAM or ROM device, as described above.

The computer or hardware system 500 also may include software elements, shown as being currently located within the working memory 535, including an operating system 540, device drivers, executable libraries, and/or other code, such as one or more application programs 545, which may include computer programs provided by various embodiments (including, without limitation, hypervisors, virtual machines (“VMs”), and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that include the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, by at least one router, a routing policy;
receiving, by the at least one router, route announcements, including route announcements that are advertised by a plurality of service applications;
receiving, by the at least one router, a data packet;
determining, by the at least one router, a customer Internet protocol (“IP”) prefix associated with a destination address of the data packet, the customer IP prefix corresponding to a customer device;
determining, by the at least one router and based on the route announcements, a plurality of routes to the destination address, including a first route through a first service application of the plurality of service applications, a second route through a second service application of the plurality of service applications, and a third route not associated with the plurality of service applications;
selecting, by the at least one router and based on at least the routing policy and local preference values associated with the plurality of routes, the first route to route the data packet;
sending, by a first router among the at least one router, the data packet to the first service application via the first route;
receiving, by one of the first router or a second router among the at least one router, the data packet from the first service application;
selecting, by the at least one router and based on at least the routing policy and local preference values associated with the plurality of routes, the second route to route the 22 data packet;
sending, by the one of the first router or the second router, the data packet to the second service application via the second route;
receiving, by one of the first router, the second router, or a third router among the at least one router, the data packet from the second service application;
selecting, by the at least one router and based on at least the routing policy and local preference values associated with the plurality of routes, the third route to route the data packet; and
sending, by the one of the first router, the second router, or the third router, the data packet to the customer device via the third route.

2. The method of claim 1, wherein the local preference values are determined based on one or more of the routing policy or the route announcements.

3. The method of claim 2, wherein sending the data packet to the first service application via the first route, to the second service application via the second route, and to the customer device via the third route is based on routing using border gateway protocol (“BGP”), wherein the local preference values comprise BGP local preference values associated with the plurality of network devices.

4. The method of claim 3, wherein selecting each of the first route, the second route, and the third route is based on a priority of the BGP local preference values associated with each of the first route, the second route, and the third route.

5. The method of claim 3, wherein selecting each of the first route, the second route, or the third route comprises:
repeating the following operations until a route having a highest priority has been identified:
determining, by the at least one router, a next highest priority route among the plurality of routes;
determining, by the at least one router, whether the data packet has already been sent to or received via the next highest priority route; and
performing one of:
based on a determination that the data packet has already been sent to and/or received from the next highest priority route, either ignoring the next highest priority route or changing the BGP local preference value to reduce priority of the next highest priority route; or
based on a determination that the data packet has not already been sent to and/or received from the next highest priority route, identifying the next highest priority route as the route having the highest priority.

6. The method of claim 3, wherein the third route is set to have the lowest priority.

7. The method of claim 1, further comprising:
after receiving the data packet from the first service application, ignoring, by the at least one router and based on the routing policy, the first route to prevent resending the data packet to the first service application.

8. The method of claim 1, wherein each of the first service application and the second service application comprises a separate broadcast domain.

9. The method of claim 1, wherein the first service application and the second service application form a first service chain that is associated with the customer device, wherein a second service chain that is associated with another customer device is different from the first service chain in terms of at least one of service applications among the plurality of service applications or an order of service applications in each service chain.

10. The method of claim 1, wherein the plurality of service applications provides a corresponding plurality of network services comprising at least one of firewall services, distributed denial of service (“DDoS”) mitigation services, network analytics services, content cache services, or encryption services.

11. A router, comprising:
a processing system; and
a memory coupled to the processing system, the memory comprising computer executable instructions that, when executed by the processing system, causes the router to perform operations comprising:
receiving route announcements, including route announcements that are advertised by a plurality of service applications;
receiving a data packet;
determining a customer Internet protocol (“IP”) prefix associated with a destination address of the data packet, the customer IP prefix corresponding to a customer device;
determining, based on the route announcements, a plurality of routes to the destination address, including a first route through a first service application of the plurality of service applications, a second route through a second service application of the plurality of service applications, and a third route not associated with the plurality of service applications;
selecting, based on at least the routing policy and local preference values associated with the plurality of routes, the first route to route the data packet;
sending the data packet to the first service application via the first route;
receiving the data packet from the first service application;
selecting, based on at least the routing policy and local preference values associated with the plurality of routes, the second route to route the data packet;
sending the data packet to the second service application via the second route;
receiving the data packet from the second service application;
selecting, based on at least the routing policy and local preference values associated with the plurality of routes, the third route to route the data packet; and
sending the data packet to the customer device via the third route.

12. The router of claim 11, wherein the local preference values are determined based on one or more of the routing policy or the route announcements.

13. The router of claim 12, sending the data packet to the first service application via the first route, to the second service application via the second route, and to the customer device via the third route is based on routing using border gateway protocol (“BGP”), wherein the local preference values comprise BGP local preference values associated with the plurality of network devices.

14. The router of claim 13, wherein selecting each of the first route, the second route, and the third route is based on a priority of the BGP local preference values associated with each of the first route, the second route, and the third route.

15. The router of claim 14, wherein the operations further comprise:
after receiving the data packet from the first service application, ignoring, by the router and based on the routing policy, the first route to prevent resending the data packet to the first service application.

16. The router of claim 14, wherein the third route is set to have the lowest priority.

17. A system, comprising:
at least one of network device hosting a plurality of service applications; and
one or more routers, each router being configured to:
receive a routing policy;
receive route announcements, including route announcements that are advertised by the plurality of service applications;
receive a data packet;
determine a customer Internet protocol (“IP”) prefix associated with a destination address of the data packet, the customer IP prefix corresponding to a customer device;
determine, based on the route announcements, a plurality of routes to the destination address, including a first route through a first service application of the plurality of service applications, a second route through a second service application of the plurality of service applications, and a third route not associated with the plurality of service applications;
select, based on at least the routing policy and local preference values associated with the plurality of routes, the first route to route the data packet;
send the data packet to the first service application via the first route;
receive the data packet from the first service application;
select, based on at least the routing policy and local preference values associated with the plurality of routes, the first route to route the data packet;
send the data packet to the second service application via the second route;
receive the data packet from the second service application;
select, based on at least the routing policy and local preference values associated with the plurality of routes, the third route to route the data packet; and
send the data packet to the customer device via the third route;
wherein each of the first service application and the second service application is further configured to:
receive a service chaining request from a customer associated with the customer device, the service chaining request including a request for the first and second service applications to perform network services on data packets that are addressed to the customer IP prefix;
advertise its route announcements to the one or more routers, its route announcements indicating to route data packets to the customer IP prefix through the service application, wherein its route announcements include its local preference value;
receive the data packet from the router;
perform at least one network service on data packet; and
send the data packet back to the router.

18. The system of claim 17, wherein the routing policy includes:
a policy to route data packets to the highest priority local preference values;
for each service chain, a policy to prevent packet loop back by either changing a local preference value of, or ignoring, a route from which the router receives data packets.

19. The system of claim 18, wherein the routing policy further includes:
for each service chain, a policy to route data packets via a route with the next highest priority local preference value when a service application corresponding to a route with the highest priority local preference stops advertising its route announcements.

20. The system of claim 17, wherein service chains for two or more different customers are different in terms of at least one of service applications among the plurality of service applications or an order of service applications in each service chain.
